(19) United States
(12) Patent Application Publication
(10) Pub. No.: US 2005/0211827 A1
(43) Pub. Date: Sep. 29, 2005

(54) High speed missile wing and associated method

(75) Inventor: Edward Barocela, Ballwin, MO (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: The Boeing Company

(21) Appl. No.: 10/811,735

(22) Filed: Mar. 29, 2004

(51) Int. Cl. B64C 3/38

(52) U.S. Cl. 244/46

(57) ABSTRACT

A high speed missile and an associated system and method are provided. The missile includes a fuselage member, and an engine carried by the fuselage member and capable of thrusting the missile to transonic speed during flight. A wing actuator is also carried by the fuselage member, and a wing member is pivotally movable by the wing actuator. Advantageously, the wing member may pivot from a fore-aft position aligned along the fuselage member to various sweep angles, and the wing actuator is capable of pivoting the wing member to a predetermined sweep angle.

### BACKGROUND OF THE INVENTION

1) Field of the Invention

The present invention relates to missiles and, more particularly, to a high speed missile including an oblique missile wing, as well as an associated system and method.

2) Description of Related Art

It is well known that wing design plays an instrumental role in increasing the lift to drag ratio (L/D) during flight. Wing design becomes especially important depending on whether the wing is subjected to subsonic, transonic, or supersonic speeds. Subsonic speeds generally occur at speeds of about less than about Mach 0.8, transonic speeds occur generally at speeds of about Mach 0.8 to 1.2, and supersonic speeds occur at speeds of about Mach 1.2 to 5.0. Thus, wings subjected to transonic speeds may experience speeds just below the speed of sound, but also experience flow fields having regions of locally subsonic and supersonic velocities. As a result, a critical velocity is reached during transonic speed when the air flowing over the wing has reached the speed of sound (Mach 1.0) at some point along the airfoil. At transonic and supersonic speeds there is a substantial increase in drag due to changes in pressure distribution, but once the speed increases past transonic, the drag decreases, and less thrust is required to fly at supersonic speed than at transonic speed.

Decreasing drag involves balancing several different parameters, including, for example, wing geometry, overall wing dimensions, and the profile of the airfoil. High speed missiles have typically used swept back wings to achieve acceptable drag at transonic speeds. This may result in a mechanically complex design, however, since most missile applications require that the wings be folded when the vehicle is to be carried by a military aircraft. A conventional swept wing design requires that both the left and right wings be separately folded back, each with its own pivot and locking mechanism.

Furthermore, although a conventional swept wing does reduce drag at transonic speeds, it is not the shape that provides the least drag. If a missile were to be designed to cruise continuously at transonic speeds, the conventional swept wing would not provide the lowest fuel consumption or the smallest size engine.

Aeronautical research efforts have shown through wind tunnel tests that an oblique wing provides lower drag at transonic speeds than conventional swept wings. Therefore, oblique wings have provided an alternative to conventionally swept wings for high-speed applications. An oblique wing can be made as a single-piece component that can be deployed with one centrally mounted wing pivot connected to the fuselage of an aircraft or missile. Typically, the wing extends at a sweep angle greater than zero and about 30 to 45 degrees during transonic or supersonic speeds. Thus, one end of the wing extends generally in the direction of flight, while the other end trails behind. A missile design employing an oblique wing generally includes a mechanism to pivot the oblique wing from an unswept position before launch to a pivoted oblique position at high speeds.

U.S. Pat. No. 3,971,535 to Jones illustrates an oblique wing utilized in an aircraft design. Missiles and aircraft experience similar lift and drag issues. U.S. Pat. No. 5,154,370 to Cox et al. (“Cox”) discloses a wing mounted on a missile that may pivot from either a stored or unswept position to an oblique position at higher speeds. Cox also discloses that the wing could be stored in a position such that the wing is aligned with the fuselage while the missile is being stowed. A wing actuator unit rotates the wing. The wing actuator unit is a motor-driven pivotal mount. Additionally, Cox discloses that the wing has a very high aspect ratio, such as 22.5 in one embodiment. Thus, Cox teaches a wing design that will preferably remain below critical velocity at speeds of 400 knots (about Mach 0.6) or lower in an unswept position and at speeds of 550 knots (about Mach 0.83) or lower at a sweep angle of 45 degrees in order to avoid unstable eddy flow and flight instability.

It would therefore be advantageous to provide a missile that can maintain transonic speeds. Also, it would be advantageous to provide a missile wing that has a reduced drag coefficient at transonic speeds, as well as reduced fuel consumption and engine size. Finally, it would be advantageous to provide a missile wing that may be easily deployed from a captive carry position to a released position.

### BRIEF SUMMARY OF THE INVENTION

The invention addresses the above needs and achieves other advantages by providing a missile capable of traveling at transonic speeds, as well as an oblique wing that may be oriented to a swept position to reduce drag. The missile wing may be pivoted to various sweep angles, and preferably to a predetermined angle such that drag is reduced for a specified speed and altitude.

In one embodiment, the missile includes a fuselage member, and an engine mounted to the fuselage member and capable of thrusting the missile to transonic speed during flight. In this regard, the missile is capable of thrusting to and maintaining transonic speeds. In variations of the present invention, the missile thrusts to transonic speeds of at least about Mach 0.9, and also maintains these speeds for at least 30 minutes. A wing actuator is carried by the fuselage member, and a wing member may be pivotally moved by the wing actuator. Advantageously, the wing member may pivot from a fore-aft position aligned along the fuselage member to various sweep angles, and the wing actuator is capable of pivoting the wing member to a predetermined sweep angle. The wing actuator may be a wound, spring-loaded actuator or an electronic actuator that may cause the wing to pivot to vary the sweep angles during flight.

The wing member may be pivotally mounted to either a lower or an upper surface of the fuselage member. The wing member may pivot to a sweep angle of approximately 30 to 40 degrees such that one end of the wing extends generally in the direction of flight, while an opposite end generally trails behind. The wing member may pivot about a midpoint or a quarter chord of the wing member. Preferably, the wing member has a low aspect ratio, such as, below 7.0.

The present invention includes further variations, such as a restraint attached to the fuselage and positioned proximate to one or both ends of the wing member to keep the wing member substantially free from vibration when positioned in a fore-aft position. Also, an antenna could be positioned within, and substantially along, an entire length of the wing member. Additionally, the missile may also include fins pivotally attached and proximate to a trailing end of the fuselage member.

In another embodiment of the present invention, an aircraft includes a missile releasably attached to the aircraft. As before, the missile further includes a fuselage member, and an engine mounted to the fuselage member and capable of thrusting the missile to transonic speed during flight. A wing actuator is carried by the fuselage member, and a wing member is capable of being pivotally moved by the wing actuator. The wing member may pivot from a fore-aft position aligned along the fuselage member to various sweep angles, and the wing actuator is capable of pivoting the wing member to a predetermined sweep angle.

The present invention further provides a method of launching a missile. The method includes releasably attaching a missile having a fuselage member to an aircraft. The method also includes releasing the missile from the aircraft, wherein the missile further comprises a wing member aligned in a fore-aft position along the fuselage member and operably connected to a wing actuator. The missile is thrust to transonic speed, such as speeds of at least Mach 0.9 that may be maintained for at least 30 minutes. In addition, the method includes pivoting the wing member to a swept position such that the wing member has a swept position during at least a portion of travel of the missile at transonic speed. In this regard, the method may also include releasing restraining pins such that fins pivotally attached and proximate to an aft portion of the fuselage are free to pivot during flight.

Optionally, the method includes pivoting the wing member to a sweep angle of approximately 30 to 40 degrees such that one end of the wing extends generally in the direction of flight and an opposite end generally trails behind. In further variations of the present invention, the method includes providing a signal from an antenna positioned within, and substantially along, an entire length of the wing member. The antenna could be used to transmit or receive a low band radio signal.

The present invention therefore provides a missile wing that reduces drag at high speeds. Advantageously, the missile includes a wing that may be deployed from a captive carry position to a swept position during flight to reduce drag at transonic speeds. The wing may be rotated to various swept positions following release, which allows the wing to be adjusted to accommodate various missiles or to achieve various drag coefficients. Also, the combination of high speeds and reduced drag permits the missile to utilize a smaller jet engine and consume less fuel than if a traditional swept wing were implemented, and the missile does not require afterburners. The missile is further capable of cruising at transonic speeds for extended periods of time and, thus, over extended distances.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a missile according to one embodiment of the present invention;

FIG. 2 is a plan view of a wing having an antenna embedded therein according to another embodiment of the present invention;

FIG. 3 is an enlarged view of a restraint between the wing and fuselage according to yet another embodiment of the present invention;

FIG. 4 is an enlarged perspective view illustrating fins locks according to an embodiment of the present invention;

FIG. 5 is a top view of the missile shown in FIG. 1;

FIG. 6 is a side view of the missile shown in FIG. 1;

FIG. 7 is a front view of the missile of the present invention, illustrating the span of the wing in an unswept position;

FIG. 8 is an enlarged perspective view illustrating a missile wing of the missile shown in FIG. 1;

FIG. 9 is an enlarged perspective view illustrating a wing actuator of the missile shown in FIG. 1;

FIG. 10 is an enlarged perspective view illustrating an electronic actuator according to another embodiment of the present invention;

FIG. 11 is a front view of a missile releasably mounted to an aircraft wing according to another embodiment of the present invention; and

FIG. 12 is a flowchart of a method of launching the missile shown in FIG. 1.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

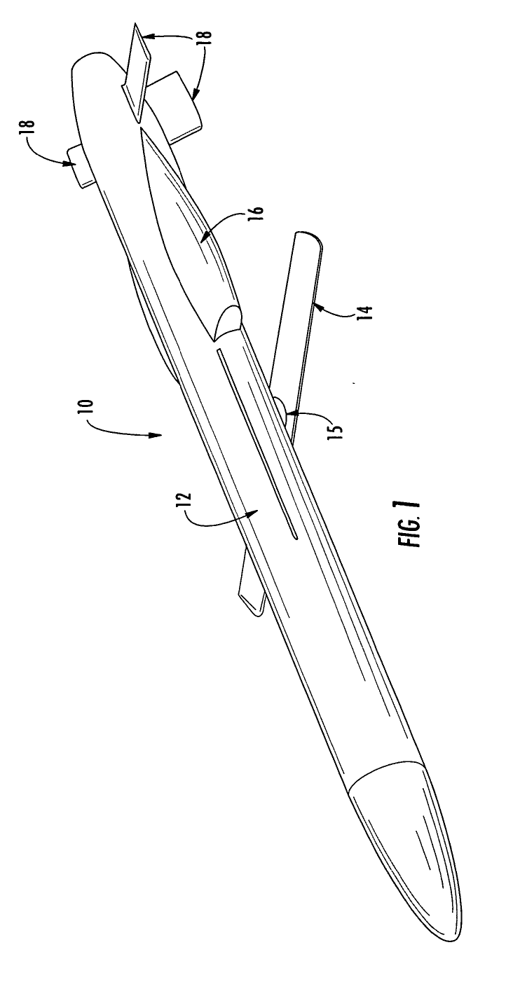

Referring now to the drawings and, in particular to FIG. 1, there is shown an air-to-surface missile 10. The missile includes a wing that may pivot from a fore-aft position during captive carry to a specified sweep angle following release using an actuator, as will be explained more fully below. Because the missile travels at transonic speeds, the orientation of the wing decreases drag, such that a smaller jet engine is required to maintain transonic speeds. Thus, the missile 10 flies at least Mach 0.9 and preferably at least 0.93, which is well within the generally accepted range of transonic speed. It is understood that the oblique wing of the present invention could also be utilized with other small airframes at transonic speeds, such as with target drones. As used herein, all of the small airframes are collectively termed “missiles.”

In one embodiment of the present invention shown in FIG. 1, the missile 10 includes a fuselage 12 having a wing 14 extending from a lower surface of the fuselage. An actuator 15 is carried by the fuselage 15 and may also be mounted to the lower surface of the fuselage 12. The wing 14 is coupled to the actuator 15 so that the wing may pivot to various sweep angles α, i.e., measured from an angle drawn between the longitudinal axis of the wing and a line extending perpendicular to the fuselage 12, as shown in FIG. 5. The missile 10 is thrust with an engine 16, such as a turbojet engine, mounted within or otherwise carried by the fuselage 12. Attached to the aft portion of the fuselage 12 are three fins 18, which are capable of pivoting during flight to provide the missile 10 with additional control and stability. Each of a pair of fins 18 is located on opposite sides of the fuselage 12, and the third fin is located on the lower surface of the fuselage. However, any number, type, and configuration of fins 18 could be employed with the present invention to achieve the desired drag and lift parameters.

The engine 16 is capable of thrusting and maintaining the missile 10 at transonic speeds. In one embodiment, the engine 16 provides about 100 lbs of force, but this can vary depending upon the size and weight of the missile 10 and the desired flight characteristics. The engine 16 of one advantageous embodiment maintains transonic speeds for at least thirty minutes and up to, and even greater than, one hour. Thus, the engine 16 can maintain the missile 10 at transonic speeds for a substantial period of time, which equates to hundreds of nautical miles. However, because the missile 10 is configured to reduce drag at transonic speed, the engine 16 could be any engine suitable to thrust or maintain transonic speeds, for any amount of time, no matter how short in duration.

The missile 10 of the present invention preferably includes a number of additional features, although any number and combination of features could be included. For example, the missile 10 includes a payload located in the fore portion of the missile. Because the missile 10 is preferably guided, the missile 10 also includes a guidance system, which comprises a mission computer, power supply, global positioning system (GPS), selective availability anti-spoofing module (SAASM) receiver (e.g., NavStrike II SAASM GPS Receiver, Rockwell Collins Gov't Systems), and an inertial measurement unit (IMU) (e.g., HG 1700 IMU, Honeywell International, Inc.). Additional features may include a fuel tank, GPS antennas, low and high band antennas, a flight termination system, beacon, and telemetry, as known to those skilled in the art.

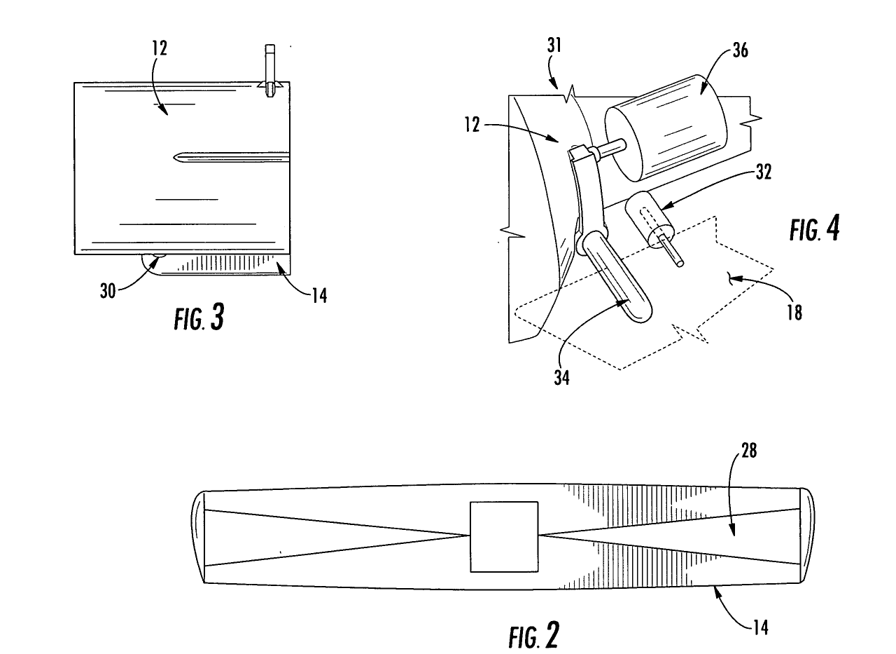

A radio frequency antenna 28 may be embedded or attached to the wing 14, such as the underside of the wing, and generally extends the entire length of the wing, as shown in FIG. 2. By using a wing 14 comprising a single piece, a longer antenna 28 may be accommodated. In contrast, a missile equipped with a conventional swept two-piece wing would be able to accommodate two smaller, separate antennas. Thus, the single piece wing 14 provides an option for integrating a low band antenna 28 with a missile 10 airframe, since low band tranceivers require longer antennas than high band devices. Such low band devices are particularly useful in detecting and jamming radar signals from certain anti-aircraft radar systems.

The missile 10 of the present invention may include each of the following optional features in alternative embodiments to improve the flight characteristics of the missile 10. As shown in FIG. 3, restraints 30, or snubbers as known to those skilled in the art, could be mounted to the fuselage 12, such as at each end of the wing 14, to minimize vibration between the fuselage and the wing during captive carry. The restraints 30 are preferably a rubber material and may be wedged between the fuselage 12 and the wing 14 to frictionally hold the wing in place, or the snubbers could be clamped on each of the wing tips. The missile 10 of the present invention may also include fin locks 31, as known to those skilled in the art, which are used to maintain the fins 18 in a neutral position during captive carry, and that may be subsequently released under the control of the mission computer, such as when a predetermined speed is reached, to allow the fins to freely pivot during flight. As shown in FIG. 4, the fin locks 31 include a solenoid 32 that locks the fins 18 in place, and once retracted, the fins may pivot about rod 34 and roller 36. Rod 34 is attached to each fin 18 such that as the roller 36 located underneath the fuselage 12 rotates due to changes in flight patterns or other circumstances, the fins may smoothly pivot. In addition, the engine 16 may include inlet covers to prevent any foreign debris from entering the inlets to the engine. The inlet covers could be jettisonable.

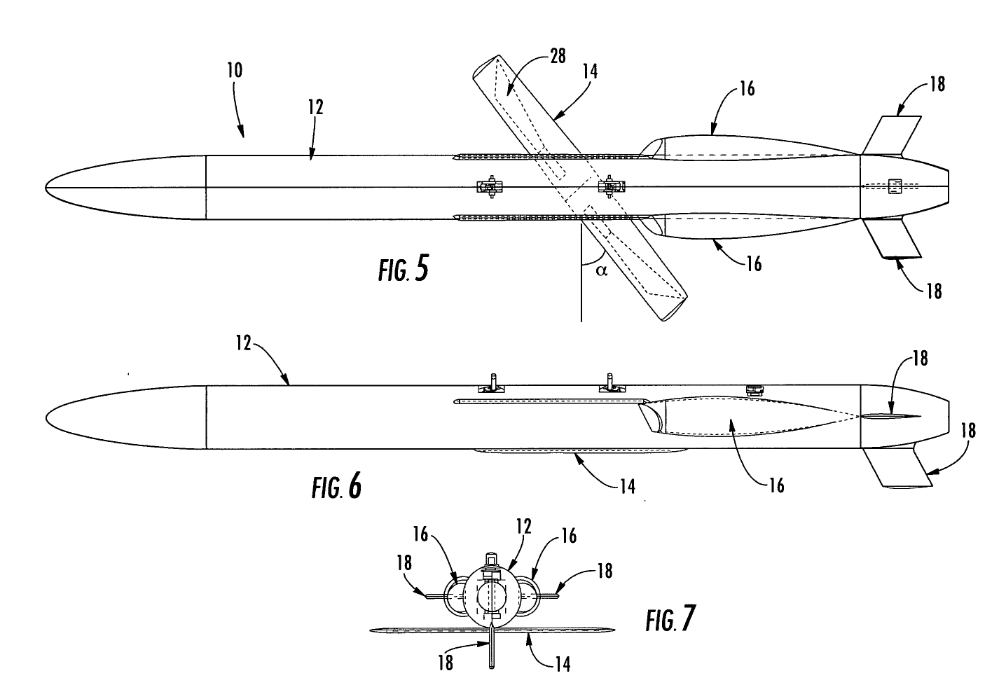

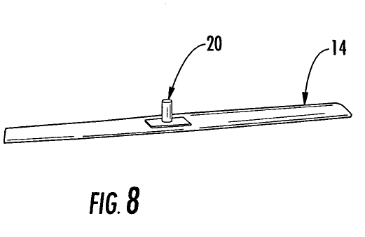

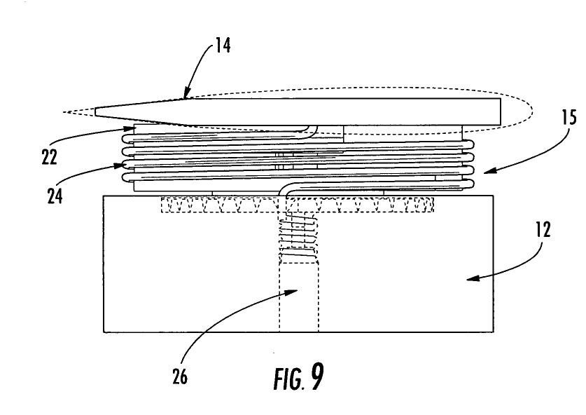

Referring now to FIGS. 5-7, one advantageous embodiment of the present invention is shown and is described in detail for purposes of example and not of limitation. The missile 10 of this embodiment is cylindrical and less than 7 inches in diameter, and about 107 inches in length. The wing 14 has a span of about 29.5 inches, and has a chord length of about 4.5 inches. Therefore, the wing 14 has an aspect ratio of about 6.5 in one embodiment. FIG. 7 shows the wing 14 being approximately perpendicular to the fuselage 12, which thus illustrates the full span of the wing in an unswept position.

It should be noted that the aforementioned features of the exemplary embodiment of the missile 10 vary as they depend on many factors. For example, the fuselage 12 could be various cross sections, such as elliptical, rectangular, or triangular. In addition, although the aspect ratio of the wing 14 is shown as being about 6.5, the aspect ratio could be even smaller for achieving higher speeds, or larger for achieving slower speeds. However, because the missile 10 preferably travels at transonic speeds, having an aspect ratio that is too large will result in a substantial increase in drag and should be avoided. Thus, an aspect ratio of 7.0 or less is generally preferred. Additionally, the profile of the airfoil could be any suitable airfoil, symmetric or asymmetric, having any number of chord lengths, leading edge radii, trailing edge angles, and thicknesses depending on the drag and lift properties desired as known to those skilled in the art.

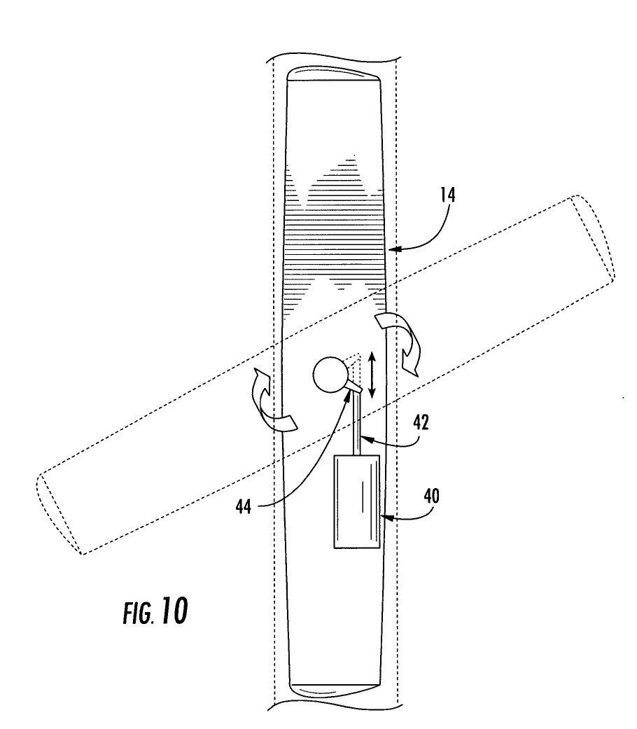

The actuator 15 of one embodiment of the present invention is illustrated in FIG. 9. The actuator is attached to either the upper or lower side of the fuselage 12, such as by welding or with fasteners, although the actuator could be carried in other manners by the fuselage and other techniques could be employed in alternative embodiments. The actuator 15 of the illustrated embodiment includes a hollow cylinder 22 having a wound spring 24 wrapped around the outer periphery of the cylinder. The spring 24 is held in place under tension with one end of the spring held in a fixed position in the fuselage 12, and the opposite end of the spring attached to, or otherwise operably engaged with, the wing 14. As shown in FIG. 8, the wing 14 includes a spindle 20 that extends approximately from the wing's midpoint and that inserts within the hollow cylinder 22. The wing 14 is held in place with a solenoid pin 26, and when the solenoid pin 26 is retracted, the wing 14 is rotated when the spring pulls back to a predetermined position, which also defines the specified sweep angle α.

Because the missile 10 could be used weeks, months, or even years after it is assembled, a spring 24 that is tightly wound or compressed may undergo creep or stress relaxation. Therefore, the spring material is advantageously selected to ensure that the actuator 15 and its components will function properly when the missile 10 is ultimately used. An example of a suitable material for the spring 24 is a coiled spring that is 0.562 inches in diameter and a 3AL-8V-6CR-4MO-4ZR titanium rod, i.e., BETA C material, RMI Titanium Company. However, it is understood that various materials for the spring 24 and actuator 15 could be incorporated to ensure that creep and stress relaxation are minimized.

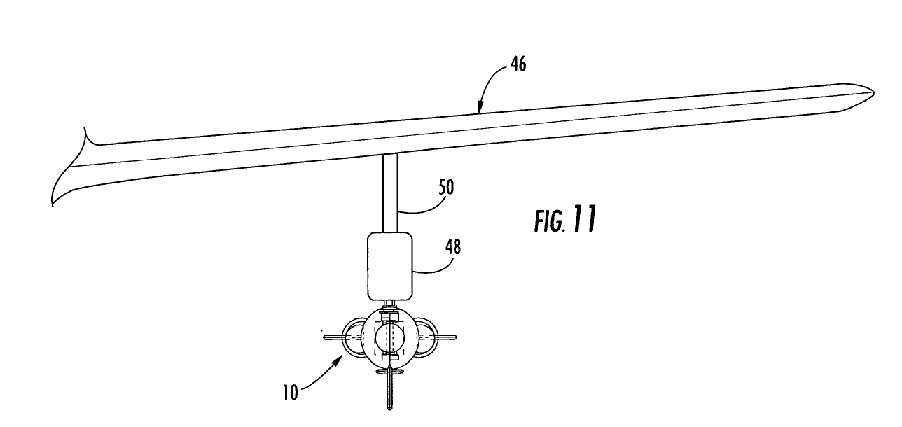

Although the illustrated embodiment shown in FIG. 9 includes a wound, spring-loaded actuator 15, it is understood that any number of actuators could be used with the present invention to achieve a desired sweep angle α following release. Thus, the actuator 15 could be electronically controlled or mechanically driven, such as with a motor. For example, U.S. Pat. No. 5,154,370 to Cox et al. discloses a motor-driven actuator to adjust the sweep angle of a wing. By way of further example, an electronically controlled actuator 38 could be used to vary the sweep angle α during flight, such as with an electric motor or solenoid. Thus, as shown in FIG. 10, a solenoid 40 could be activated to push a rod 42 in or out to cause a lever arm 44 to rotate. The lever arm 44 would, in turn, be connected to the wing 14 to rotate the wing 14 to predetermined sweep angles. The actuator 15 shown in FIG. 10 is preferably located entirely within the missile. Alternatively, the actuator 15 could be spring loaded, as discussed above, but could have multiple solenoid pins 26 and stopping points to cause the spring 24 to stop at various sweep angles α when unwound.

The wing 14 is advantageously a one-piece oblique wing. The wing 14 is aligned in a fore-aft direction along the fuselage, such as on the lower surface of the fuselage 12 such that the wing is substantially aligned with the fuselage 12 during captive carry and until the missile 10 is released and the solenoid 26 activated. The wing 14 is oriented to a sweep angle α of about 30 to 40 degrees by the actuator 15 operating under the control of the mission computer or other device when the solenoid pin 26 is retracted. The wing 14 is preferably connected to the actuator 15 at its midpoint. One end of the wing 14 points generally in the direction of flight, while the opposite end trails behind so that the leading edge of the airfoil is positioned generally fore and the trailing edge of the airfoil is positioned generally aft.

As discussed above, the dimensions of the wing 14 and airfoil profile may be varied depending on the desired L/D ratio and drag coefficient. For example, an aspect ratio of 7.0 or less is generally preferred. Additionally, the wing 14 could be any suitable material, such as aluminum or lightweight composite. If an antenna 28 is to be embedded in the wing 14, a material that is transparent to radio waves is preferable, such as a glass/epoxy composite. Although, it is preferred that the wing 14 assumes a sweep angle α of about 30 to 40 degrees, it is understood that any specified angle could be employed with the missile 10 of the present invention to achieve a desired drag coefficient. It is also understood that the wing 14 could be connected to the actuator 15 at its quarter chord, or any other desired location along the span of the wing. In addition, although the wing 14 is shown in FIGS. 1-4 as being located on a lower surface of the fuselage 12, the wing could be located on the upper or other surface of the fuselage.

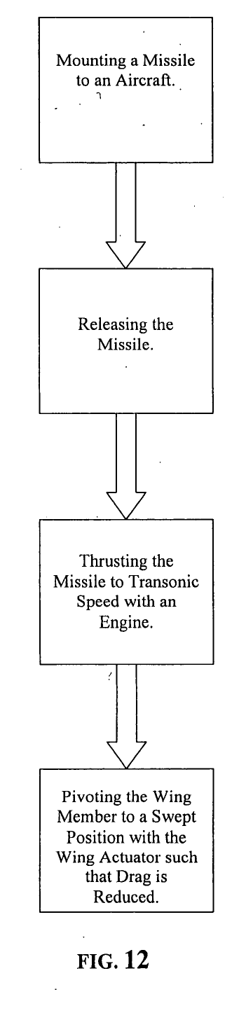

As shown in FIG. 11, the missile 10 of the present invention may be attached to the underside of an aircraft wing 46. The missile 10 is typically attached to an ejector rack 48, and the ejector rack is attached to a pylon 50 that mounts to the underside of the aircraft wing 46, although it is understood that any technique known to those skilled in the art could be used to releasably attach the missile to the aircraft wing. As mentioned previously, the missile 10 includes its own guidance controls, so once released, a computer and power supply are booted to trigger the other components of the missile. Thus, as shown in the flowchart illustrated in FIG. 12, the mission computer in the missile 10 is programmed to initiate the engine 16, as well as the solenoid pin 26 on the actuator 15 to cause the wing 14 to pivot from a captive carry position to a swept position once the missile has been released. In addition, other features of the missile 10 would be initiated following release, such as, the GPS and IMU units, and the mission computer would also trigger an actuator to release the locks on the fins 18 so that the fins are freely pivotable. It is understood that the missile 10 could also be mounted to the aircraft at various locations on the missile's fuselage 12, such as on its side, especially in instances where the wing 14 is connected to the actuator 15 on an upper surface of the fuselage, or where multiple missiles are being carried on one aircraft wing. Similarly, the missile 10 can be mounted to various locations on the aircraft rather than on the aircraft's wing, such as on a lower portion of the aircraft's fuselage. With the addition of a small rocket booster to accelerate it to flight speed, the missile 10 could also be adapted to be launched from the ground.

In flight, the wing 14 is oriented to a sweep angle α, which is known to produce lower drag at transonic speeds than would a swept or unswept wing. Testing has indicated that the missile 10 of the present invention may obtain L/D ratios exceeding 4 at an angle of attack of about 4 degrees and Mach 0.9, and a drag coefficient of less than 0.005 at Mach 0.9. Because drag is reduced, a smaller engine is required and less fuel is consumed for higher speeds than would a swept wing under the same conditions.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A missile comprising:
a fuselage member;
an engine carried by the fuselage member and capable of thrusting the missile at transonic speed during flight;
a wing actuator carried by the fuselage member; and
a wing member pivotally connected to the fuselage member, wherein the wing member is pivotable by the wing actuator from a position substantially aligned with the fuselage member to a predetermined sweep angle.

2. A missile according to claim 1, wherein the wing member has an aspect ratio of less than about 7.0.

3. A missile according to claim 1, wherein the wing member is pivotally mounted to a lower surface of the fuselage member.

4. A missile according to claim 1, wherein the wing member is pivotally mounted to an upper surface of the fuselage member.

5. A missile according to claim 1, wherein the wing member is pivoted to a sweep angle of approximately 30 to 40 degrees such that one end of the wing extends generally in the direction of flight and an opposite end generally trails behind.

6. A missile according to claim 1, wherein the wing member is pivotally attached to the fuselage member proximate to the midpoint of the wing member.

7. A missile according to claim 1, wherein the wing member is pivotally attached to the fuselage member proximate to a one-quarter chord of the wing member.

8. A missile according to claim 1, wherein the fuselage member has a diameter of less than about 7 inches.

9. A missile according to claim 1, wherein the missile may thrust to transonic speeds of at least about Mach 0.9.

10. A missile according to claim 1, wherein the missile may thrust to and maintain transonic speeds for at least 30 minutes during flight.

11. A missile according to claim 1, further comprising a restraint attached to the fuselage and positioned proximate to each end of the wing member such that when the wing member is substantially aligned with the fuselage member, the wing member is substantially free from vibration.

12. A missile according to claim 1, further comprising an antenna positioned within, and substantially along, an entire length of the wing member.

13. A missile according to claim 1, wherein the wing actuator comprises a wound, spring-loaded actuator.

14. A missile according to claim 1, wherein the wing actuator comprises an electronic actuator that may vary the sweep angles during flight.

15. A missile according to claim 1, further comprising fins pivotally attached and proximate to a trailing end of the fuselage member.

16. A missile system comprising:
an aircraft; and
a missile releasably attached to the aircraft, the missile comprising:
a fuselage member;
an engine carried by the fuselage member and capable of thrusting the missile to transonic speed during flight;
a wing actuator carried by the fuselage member; and
a wing member pivotally connected to the fuselage member, wherein the wing member is pivotable by the wing actuator from a position substantially aligned with the fuselage member to a predetermined sweep angle.

17. A missile according to claim 16, wherein the wing member has an aspect ratio of less than about 7.0.

18. A missile system according to claim 16, wherein the wing member is pivotally mounted to a lower surface of the fuselage member.

19. A missile system according to claim 16, wherein the wing member is pivotally mounted to an upper surface of the fuselage member.

20. A missile system according to claim 16, wherein the wing member has a sweep angle of approximately 30 to 40 degrees such that one end of the wing extends generally in the direction of flight and an opposite end generally trails behind.

21. A missile system according to claim 16, wherein the missile may thrust to transonic speeds of at least about Mach 0.9.

22. A missile system according to claim 16, wherein the missile may thrust to and maintain transonic speeds for at least 30 minutes.

23. A method of launching a missile comprising the steps of:
mounting a missile to an aircraft such that the missile is releasably attached, wherein the missile comprises a fuselage member;
releasing the missile from the aircraft, wherein the missile further comprises a wing member substantially aligned with the fuselage member;
thrusting the missile to transonic speed; and
pivoting the wing member to a swept position such that the wing member has a swept position during at least a portion of travel of the missile at transonic speeds.

24. The method according to claim 23, wherein pivoting includes pivoting the wing member to a sweep angle of approximately 30 to 40 degrees such that one end of the wing extends generally in the direction of flight and an opposite end generally trails behind.

25. The method according to claim 23, wherein thrusting includes thrusting the missile to transonic speeds of at least about Mach 0.9.

26. The method according to claim 23, wherein thrusting includes thrusting the missile such that transonic speeds are maintained for at least 30 minutes.

27. The method according to claim 23, further comprising providing a signal from an antenna positioned within, and substantially along, an entire length of the wing member such that the antenna may can transmit or receive a low band radio signal.

28. The method according to claim 23, further comprising releasing restraining pins such that fins pivotally attached and proximate to a trailing end of the fuselage are free to pivot during flight.
